(19) United States
(12) Patent Application Publication
(10) Pub. No.: US 2024/0095493 A1
(43) Pub. Date: Mar. 21, 2024

(54) DESPARSIFIED CONVOLUTION FOR SPARSE TENSORS

(71) Applicant: QUALCOMM Incorporated, San Diego, CA (US)

(72) Inventors: Jamie Menjay LIN, San Diego, CA (US); Jian SHEN, San Diego, CA (US)

(21) Appl. No.: 17/932,527

(22) Filed: Sep. 15, 2022

(51) Int. Cl. G06N 3/04; G06F 7/50; G06F 7/523

(52) U.S. Cl. CPC G06N 3/04; G06F 7/50; G06F 7/523

(57) ABSTRACT

Certain aspects of the present disclosure provide techniques for desparsified convolution. A weight tensor having unstructured sparsity is accessed, and a densified weight tensor is generated based on the weight tensor by directionally squeezing the weight tensor to remove sparse values, and generating a sparsity map based on the directional squeezing. The densified weight tensor and sparsity map are output for use in a convolutional neural network.

### INTRODUCTION

Aspects of the present disclosure relate to efficient convolution operations.

Convolution has become an increasingly important operation for a wide variety of computational solutions, including in convolutional neural networks, which often involve applying a large number of convolution operations to input data. Convolutional neural networks can be trained for myriad tasks, such as computer vision (e.g., image or object recognition), audio processing, and the like. Generally, a single convolution operation involves multiplying one or more portions of an input tensor with one or more weights in a convolution kernel, where the weights are learned during a training process. Conventional convolution operations and networks typically require a massive number of such multiplications owing to a number of factors, including the size of the data tensors (e.g., the number of elements), the number of applications of each kernel, the number of kernels, the number of layers, and the like.

Generally, training of the neural network involves iteratively refining the parameters (e.g., weights) based on training data. In many cases, a significant portion of the weights or other parameters reach negligible or nearly-negligible values (e.g., at or near zero), and these weights generally have no impact (or very little impact) on the output of the network. In such systems, the weight tensors may be referred to as “sparse” (e.g., if a significant portion of the elements have a value of zero).

Accordingly, techniques are needed for improved convolution using sparse weight tensors.

### BRIEF SUMMARY

Certain aspects provide a method, comprising: accessing a weight tensor having unstructured sparsity; generating a densified weight tensor based on the weight tensor, comprising: directionally squeezing the weight tensor to remove sparse values; and generating a sparsity map based on the directional squeezing; and outputting the densified weight tensor and sparsity map for use in a convolutional neural network.

Certain aspects provide a method, comprising: accessing an activation tensor for processing using a convolution operation; and performing the convolution operation, comprising: retrieving a densified weight tensor for the convolution operation; retrieving a sparsity map associated with the densified weight tensor; generating a set of intermediate tensors by multiplying the densified weight tensor and the activation tensor; and generating an output tensor for the convolution operation by accumulating the set of intermediate tensors based on the sparsity map.

Other aspects provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for densifying weight tensors for improved convolution.

FIG. 2A depicts an example workflow for generating sparsity maps using absolute indications.

FIG. 2B depicts an example workflow for generating sparsity maps using relative indications.

FIG. 3 depicts an example workflow for performing convolution and sparse accumulation using densified weight tensors.

FIG. 4 depicts an example flow diagram illustrating a method for densifying weight tensors.

FIG. 5 depicts an example flow diagram illustrating a method for selectively densifying weight tensors.

FIG. 6 depicts an example flow diagram illustrating a method for performing desparsified convolution using densified weight tensors.

FIG. 7 depicts an example flow diagram illustrating a method for densifying tensors using directional squeezing.

FIG. 8 depicts an example flow diagram illustrating a method for convolving with densified weight tensors.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for improved tensor densification (alternatively referred to as desparsification), as well as improved convolution, referred to herein as desparsified convolution.

Conventional approaches to convolution often ignore weight sparsity, and, for example, convolve all elements of the weight tensor(s) with input tensors, even though convolving an element with a value of zero has no effect on the output of the convolution. This wastes energy, time, and computational resources. Some conventional approaches to handle weight sparsity rely on highly structured or semi-structured sparsity, where the allowable sparsity is strictly controlled (e.g., to perfectly distribute sparsity, which may be defined as elements with values of zero, or within a defined distance from zero) into defined portions of the weight tensors). Though this structured sparsity can achieve valuable benefits, it nevertheless introduces artificial restrictions on the sparsity, and can thereby fail to deliver optimal results as well as negatively impacting model accuracy.

Additionally, conventional approaches for handling weight sparsity often introduce significant overhead (e.g., due to unstructured model compression) at inference time. In some cases, the added overhead can overshadow the benefits of the compression, and in many cases it is better to use an uncompressed model (even one with significant sparsity) than to use the conventional sparsity approaches.

In aspects of the present disclosures, parameter tensors (e.g., weights in a neural network) can be densified using directional squeezing to remove elements satisfying defined sparsity criteria (e.g., equal to or within a threshold distance from a value of zero). In some aspects, this directional squeezing can efficiently compress the weight tensor, thereby reducing the storage and memory footprint of the tensor, as well as reducing transmission overhead (e.g., if the tensor or the model is transmitted over a network or over a local data bus). Further, the densified tensors can be used efficiently during runtime, thereby enabling rapid and efficient convolution. Notably, aspects of the present disclosure can operate with entirely unstructured sparsity without significant overhead, thereby improving the potential gains of the densification (e.g., allowing the process to be guided by the sparsity, rather than forcing the sparsity to fit a defined structure) while maintaining high inference efficiency.

In some aspects, convolution is discussed as one example process that can be improved using the densifying and sparse accumulation processes described herein. However, aspects of the present disclosure are readily applicable to a wide variety of operations, including transformer operations, sparse transformer and transformer-like operations (e.g., in Lambda networks), graph transformers, graphical neural networks, and the like.

In some aspects of the present disclosure, a squeeze operation is used to densify or compress tensors by removing zero-value elements and vertically or horizontally squeezing the remaining elements in the tensor to yield a densified or compressed tensor, as discussed in more detail below. As used herein, a data element may be referred to as “sparse” or “zero-value” to indicate that its value is equal to, or within a defined distance from, zero. That is, some small values that are technically non-zero may nevertheless be referred to as “zero-value” or “sparse” elements. Additionally, in some aspects, a map (referred to in some aspects as a sparsity map, accumulator map, or densification map) can be generated based on this squeeze operation. The sparsity map generally indicates the associations between the elements of the densified parameter tensor (e.g., the non-zero weights) and output elements (e.g., accumulators in the case of convolution). In at least one aspect, the sparsity map is of the same size as the densified tensor, enabling rapid mapping of convolution products to the corresponding accumulator during convolution operations. This enables efficient, rapid, and accurate densification and use of tensors having unstructured sparsity. In turn, the techniques disclosed herein can reduce compute time, reduce power usage, reduce memory needs, enable machine learning to be performed on a wider variety of (potentially low power) devices, and the like.

### Example Workflow for Densifying Weight Tensors

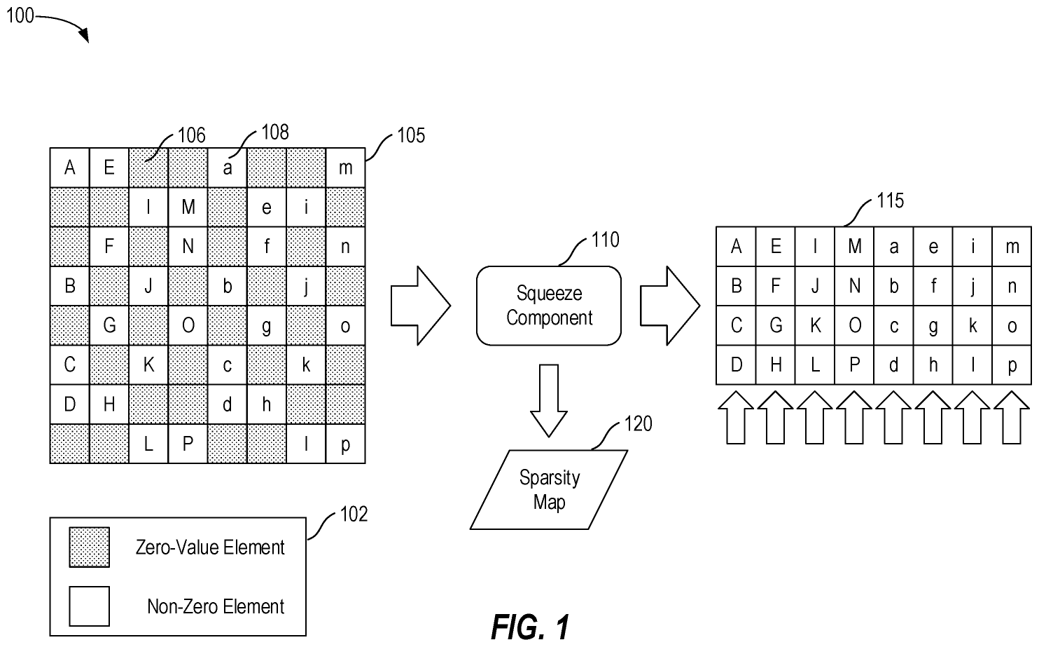

FIG. 1 depicts an example workflow 100 for densifying weight tensors for improved convolution.

In the illustrated example, a weight tensor 105 (e.g., a weight tensor for a convolution operation in a neural network) is processed by a squeeze component 110 to yield a densified tensor 115 and a sparsity map 120. Although depicted as a discrete component for conceptual clarity, in some aspects, the operations of the squeeze component 110 may be implemented as part of other components or processing (e.g., by a compiler at compile time after the network is trained). Generally, the operations of the squeeze component 110 can be implemented using hardware, software, or a combination of software and hardware.

In the workflow 100, as indicated by the legend 102, sparsity in the weight tensor 105 is indicated using stippling. Specifically, elements that are stippled are zero-value elements (e.g., element 106), indicating that the value of the element is zero (or within a defined distance from zero, in some aspects), while non-stippled elements area non-zero (e.g., element 108), indicating that the value of the element is not zero (or is greater than the defined threshold distance from zero, in some aspects). In the illustrated example, each non-zero element includes a letter for ease of reference. For example, the upper-left element of the weight tensor 105 is non-zero and has a value represented by “A,” while the upper-right element is represented by a value of “m.”

As discussed above and used herein, an element may be referred to as “zero-value” or “sparse” if it meets one or more defined sparsity criteria. In one aspect, the sparsity criteria indicate that the element is sparse or zero-value if it has an actual value of zero. In some aspects, the element may be zero-value or sparse if the corresponding value is within a threshold distance from zero (e.g., plus or minus 0.001). Further, it is possible that a threshold may be defined asymmetrically about a target value, such as zero.

As discussed above, traditional systems typically perform convolution using the weight tensor 105 directly, which inherently involves a significant number of multiplications that use “zero-value” elements. These multiplications require significant computational overhead, but have no (or little) impact on the output of the operation. However, by creating the densified tensor 115, aspects of the present disclosure enable the convolution to be performed efficiently and with reduced computational resources including memory, storage, processor time, and the like.

In the illustrated example, the squeeze component 110 generates the densified tensor 115 by vertically squeezing the weight tensor 105 from the bottom towards the top. That is, the squeeze component 110 can vertically squeeze the tensor, removing zero-value elements, to yield a densified tensor of non-zero elements. Although the illustrated example includes no zero-value elements in the densified tensor 115, in some aspects, one or more zero-value elements may remain, (e.g., to allow for more efficient use of relative spacing indication) as discussed in more detail below.

Further, though the illustrated example depicts squeezing from the bottom towards the top, the system may similarly squeeze from the top towards the bottom. Additionally, though the illustrated workflow 100 includes vertical squeezing, in some aspects, the squeeze component 110 may perform horizontal squeezing (e.g., from left to right, or from right to left). In some aspects, the direction used for the directional squeeze may differ depending on the particular implementation. In at least one aspect, the squeeze direction may be selected (e.g., by the squeeze component 110, or predefined by a user) based on a variety of criteria, such as the dimensionality of the weight tensor 105, the capabilities of the inferencing device (e.g., the device(s) that will use the densified weight tensor during runtime), and the like. That is, the hardware design that will be used to perform the multiplication and accumulation may be better-suited to process row-wise first before iterating column-wise (or vice versa), such as due to read/write access practices or benefits, such that horizontal squeezing or vertical squeezing may be preferable.

Generally, the directionality of the squeezing may affect the convolution and/or accumulation process when using the densified tensor. For example, vertical squeezing (as in the illustrated example) can generally enable operand association to be maintained, which can simplify or facilitate efficient multiplication. This is because, in some aspects, convolving the weight tensor 105 (or densified tensor 115) with an activation tensor involves multiplying each element in the activation tensor with the elements in a given column of the weight tensor 105. Therefore, by vertically squeezing the weight tensor 105, each element in the densified tensor 115 remains in the same column as its column in the weight tensor 105, thereby facilitating the multiplication (e.g., by enabling conventional multiplication logic or hardware to be used).

However, as discussed in more detail below, this vertical squeezing may cause the elements in the densified tensor 115 to lose their prior association with the proper output elements for the convolution (e.g., for the proper accumulator). This is because the elements in a given row of the weight tensor 105 are generally used to determine an output element for that row, and vertical squeezing can shift the elements into different rows in the densified tensor 115, causing the association may be lost. In some aspects, horizontal squeezing can maintain this output element association, such that the multiplication process may involve some additional overhead, but the accumulation process is easy and efficient (e.g., using conventional logic or hardware).

In aspects, the sparsity of the weight tensor 105 may generally be relatively random and evenly distributed. However, as discussed above, aspects of the present disclosure do not require such random or even distributions, and do not impose any structure on the sparsity. To allow for this unstructured sparsity and enable accurate mapping of products to accumulators (or of operands, in the case of horizontal squeezing), in an aspect, the squeeze component 110 can generate a sparsity map 120 for the densified tensor 115. As discussed in more detail below, in some aspects, the squeeze map 120 can indicate the associations between the elements in the densified tensor 115 and the corresponding output elements of the convolution process. That is, for each element in the densified tensor 115 (and therefore for each product generated by multiplying some value in an activation tensor with an element in the densified tensor 115), the sparsity map 120 may indicate (or be used to derive) the corresponding element in the output tensor. In the case of horizontal squeezing, the sparsity map 120 may indicate the proper mapping of operands (e.g., weights to input activations) to facilitate multiplication.

In at least one aspect, the sparsity map 120 may be used to indicate the associations in multiple dimensions. For example, if a vertical squeeze operation results in columns of uneven size (e.g., with more non-zero elements in some columns), then the system may shift some set of elements from the larger columns to smaller columns, and update the sparsity map 120 to indicate not only the vertical shift of these elements (caused by the vertical squeeze) but also the horizontal shift (employed to balance the columns).

In many systems, the weight tensor 105 has more elements than the convolution hardware (e.g., multiply and accumulate (MAC) arrays) can process in a single cycle. Therefore, the weight tensor 105 may be divided into multiple portions for separate processing (e.g., first processing the top half of the tensor, followed by the bottom half). As the densified tensor 115 is generally smaller in size than the original weight tensor 105, therefore, it is possible that fewer compute cycles are needed to perform the convolution. This reduces computational latency and improves efficiency of the process.

Additionally, although the illustrated example depicts a uniform densified tensor 115 (as each column of the weight tensor 105 had exactly four non-zero values), in aspects, the unstructured nature of the densification process can allow for more or fewer elements in a given column (or row, in the case of horizontal squeezing). In some aspects, these additional elements may require one or more additional cycles to perform the convolution. For example, suppose the system hardware is capable of processing 32 weights per cycle (e.g., a weight tensor, or portion thereof, with a width of four and a height of eight). If the densified tensor 115 has five weights in one or more columns, then these extra weights may be processed in a subsequent cycle (after the bulk of the densified weight tensor 115 is processed).

In some aspects, however, this overflow is generally limited to the end of the convolution process. That is, in many cases, the weight tensor 105 is larger than the size of the hardware, and is therefore subdivided into a set of sub-tensors for processing (sequentially or in parallel using separate hardware). If the sparsity is distributed unevenly, such that some portions of the weight tensor 105 are denser than others, then the densified tensor 115 may similarly have some unevenness (e.g., with some columns having more elements than others). However, as the densified tensor 115 may be delineated into portions for the actual convolution, the overflow from one portion can generally be added to the subsequent portion, and therefore no extra compute cycles are required for most of the tensor. In some cases, the last portion of the tensor being processed may result in overflow that requires one additional compute cycle. However, this extra cycle at the end nevertheless results in significantly fewer cycles overall to complete the convolution.

In some aspects, as the weights are static after training, the densified weight tensor 115 can be generated offline (e.g., before runtime inferencing). For example, the squeeze component 110 may generate the densified tensor 115 and sparsity map 120 at compile-time (e.g., while the overall neural network is being compiled, after training).

### Example Workflows for Generating Sparsity Maps

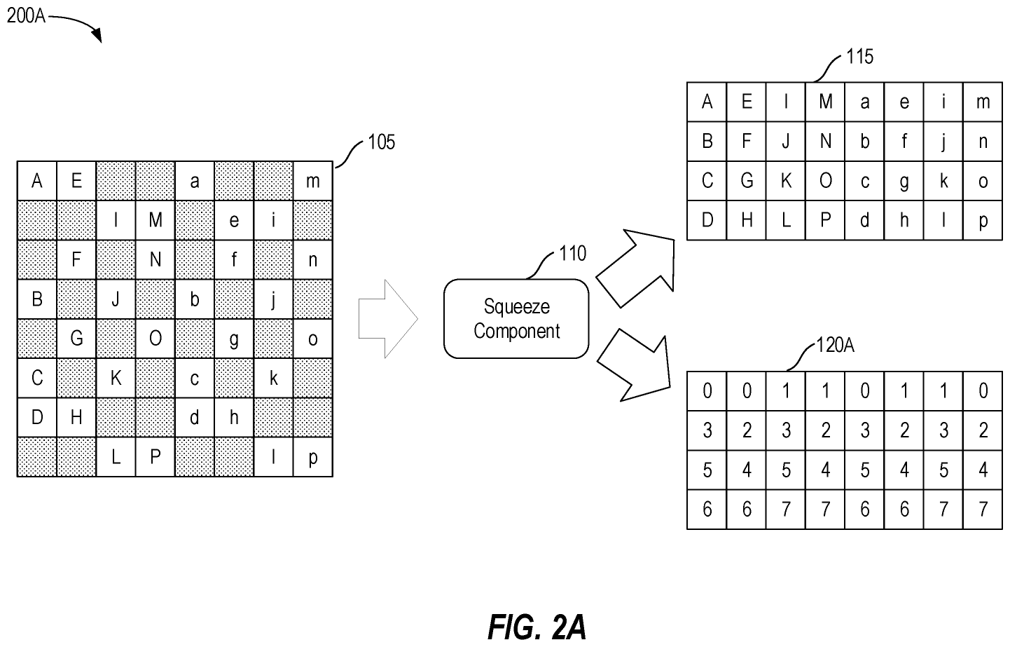

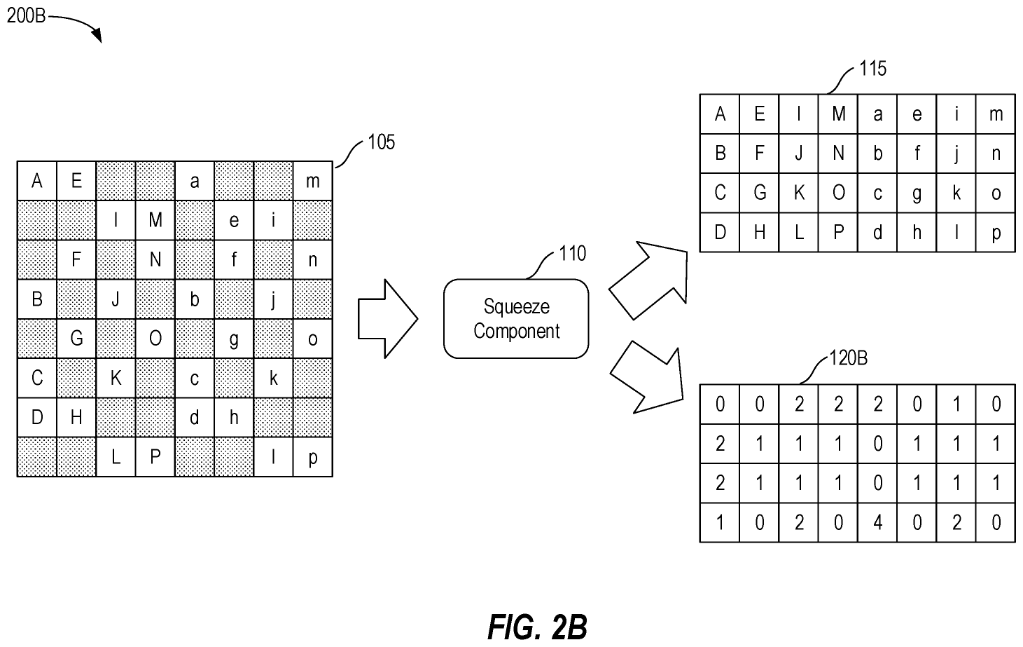

FIG. 2A depicts an example workflow 200A for generating sparsity maps, such as sparsity map 120 described with respect to FIG. 1, using absolute indications.

In the illustrated example, the weight tensor 105 is densified using directional squeezing to yield a densified tensor 115, as discussed above. Additionally, as discussed above, the sparsity map 120A is generated to indicate the associations between the non-zero elements of the input tensor 105 (e.g., the elements in the densified weight tensor 115) and the elements of the output tensor. As illustrated, the sparsity map 120A generally has the same number of elements as the densified tensor 115. In this way, each element in the densified tensor 115 can have a corresponding element in the sparsity map 120A, where the value of the element in the sparsity map 120A indicates the index of the corresponding output element for the element in the densified tensor 115. In some aspects, the sparsity map 120A has the same dimensionality (e.g., the same height and width) as the densified tensor 115.

As discussed above, each row of the weight tensor 105 generally corresponds to a given output element in the output tensor. That is, for a given element in the output tensor, the weights from a corresponding row in the weight tensor 105 are multiplied by one or more elements in an input tensor (e.g., in an activation tensor), and then accumulated (e.g., summed) to form the output element.

For example, in the illustrated example, the weights “A,” “E,” “a,” and “m,” which are all in the first row of the input tensor 105, should be used to compute the first output element (e.g., the element in the first row of the output tensor, at index 0). If the weight tensor 105 was processed in its raw state (e.g., without being densified), then the products generated using these weights can easily be accumulated using a static mapping. However, as illustrated, the first row of the densified tensor 115 also includes elements (“I,” “M,” “e,” and “i”) that should be used to generate the second row of the output tensor (at index 1).

As illustrated, the sparsity map 120A indicates the index of the corresponding output element for each weight in the densified tensor 115, and can therefore be used to determine, for each weight in the densified tensor 115, the corresponding output element. In the illustrated example, the sparsity map 120A uses absolute indicators, where the values of the sparsity map 120A directly indicate the corresponding row or element of the output tensor for each element in the densified tensor 115. In the depicted workflow 200A, the sparsity map 120A has the same dimensionality as the densified tensor 115, such that each value in the sparsity map 120A is in the same index as its corresponding weight in the densified tensor 115.

As illustrated, the absolute indications depicted in the sparsity map 120A explicitly indicate, for each weight in the densified tensor 115, the corresponding element of the output tensor (based on their original row in the weight tensor 105). Specifically, the first two elements (“A” and “E”) correspond to the 0-th row of the output (for zero-indexed mappings), the next two (“I” and “M”) correspond to the 1^{st} row, and so on. During runtime, when the densified weight tensor 115 is convolved with an input tensor (e.g., a set of activations), each product (e.g., the result of multiplying a given weight with a given activation) can be provided to the appropriate accumulator (and therefore, to the appropriate output element) based on these absolute mappings.

In some aspects, if the weight tensor 105 is large, then the absolute indications used in the sparsity map 120A can similarly be quite large. For example, if the weight tensor 105 has a height of eight, then three bits can be used to express which row a given weight belongs to. Thus, for a weight tensor having a height of eight, each element in the sparsity map 120A requires three bits. As discussed above, however, the weight tensors are often significantly larger. If the weight tensor 105 has a height of 256, then 8 bits may be needed for each element to represent the absolute indications of the sparsity map 120A. Generally, for a height of A (which may therefore require A accumulators), each element in the sparsity map 120A requires log₂∥A∥ bits.

In some aspects, therefore, the sparsity map 120A may itself become significantly large, offsetting some of the efficiencies that are realized using the directional squeezing discussed above. In at least one aspect, therefore, the squeeze component 110 can use relative indications in the sparsity map, as discussed below with reference to FIG. 2B.

FIG. 2B depicts an example workflow 200B for generating sparsity maps, such as sparsity map 120 described with respect to FIG. 1, using relative indications.

In the illustrated example, as discussed above, the weight tensor 105 is densified using directional squeezing to yield a densified tensor 115. Additionally, as discussed above, a sparsity map 120B is generated to indicate the associations between the non-zero elements of the input tensor 105 (e.g., the elements in the densified weight tensor 115) and the elements of the output tensor. However, in contrast to the sparsity map 120A of FIG. 2A, which used absolute mappings, the sparsity map 120B uses relative indications.

As illustrated, similarly to the sparsity map 120A of FIG. 2A, the sparsity map 120B generally has the same number of elements as the densified tensor 115. In some aspects, the sparsity map 120B has the same dimensionality (e.g., the same height and width) as the densified tensor 115. The sparsity map 120B and densified weight tensor 115 can be used to theoretically reconstruct the original input weight tensor 105.

As illustrated, the sparsity map 120B includes values indicating the relative spacing of the weight elements, allowing for implicit derivation of the association between weights/products and the corresponding output element/accumulator. In the depicted example, the values correspond to the horizontal gap between elements in the weight tensor 105, and the association between weights (or products) and accumulators can therefore be sequentially derived by specifying or identifying the gap to the next product.

That is, in some aspects, the values in the sparsity map 120B may indicate, for each element of the densified tensor 115, how many (zero-value) elements were skipped or removed when squeezing the weight tensor 105 (moving from right to left, and top to bottom, in the illustrated example) (or how many elements need to be skipped in the densified tensor 115 to identify the correct next weight). For example, the first weight “A” has a gap of 0, the second weight “E” has a gap of 0, and the third weight (the third non-zero entry in the weight tensor 105) “a” has a gap of 2, and so on.

In some aspects, as discussed above, each non-zero weight in a given row of the original tensor 105 (e.g., the i-th) row are used to generate products associated with a corresponding accumulator (e.g., the i-th accumulator). Thus, by referring to the relative gaps indicated in the sparsity map 120B, the system can correctly map the products to corresponding accumulators.

It should be understood that although reconstructing the tensor 105 is given as an illustrative example to conceptualize the information contained in the sparsity map 120B, in aspects, the system may simply use the values in the sparsity map 120B to drive accurate accumulation without explicitly reconstructing the original tensor 105.

In one aspect, sparsity map 120B can be used to enable offline derivation of the accumulator mappings. That is, the proper mappings to accumulate the products of the multiplication can be correctly and efficiently derived offline, prior to runtime inferencing. Stated differently, the accumulator indices can be derived for each of the non-zero entries of weight tensor 105 (e.g., each element in the densified tensor 115) by properly accumulating the running gap values from the sparsity map 120B.

In an aspect, to build the sparsity map 120B using relative indications of the spacing, the i-th Acc needs Aᵢ entries such that Σⱼgⱼ+r=Cᵢₙ, where, gⱼ's are consecutive gaps in the weight tensor 105, r is the residual gap prior to reaching the Cᵢₙ for Acc Aᵢ, and Cᵢₙ is the input channel size.

By using relative indications, the sparsity map 120B is able to use smaller values to indicate the weight associations, as compared to the absolute indications used by the sparsity map 120A of FIG. 2A. In this way, the sparsity map 120B can generally use fewer bits to represent the mappings. In some aspects, the number of bits used for each such element can be defined offline (e.g., by a user, or automatically determined based on the largest or average gap size in the weight tensor 105).

In some aspects, when a gap value for a given entry in the sparsity map 120B is larger than the allocated set of bits, the squeeze map 110 can dynamically insert a zero-value element (e.g., a weight of zero) into the densified tensor 115 at the corresponding location (e.g., in the middle of the large gap). This can allow the sparsity map 120B to include relative spacing with reference to that inserted zero value, thereby bridging the otherwise large gap with two smaller gaps (and thereby requiring fewer bits for each element).

### Example Workflow for Performing Sparse Accumulation

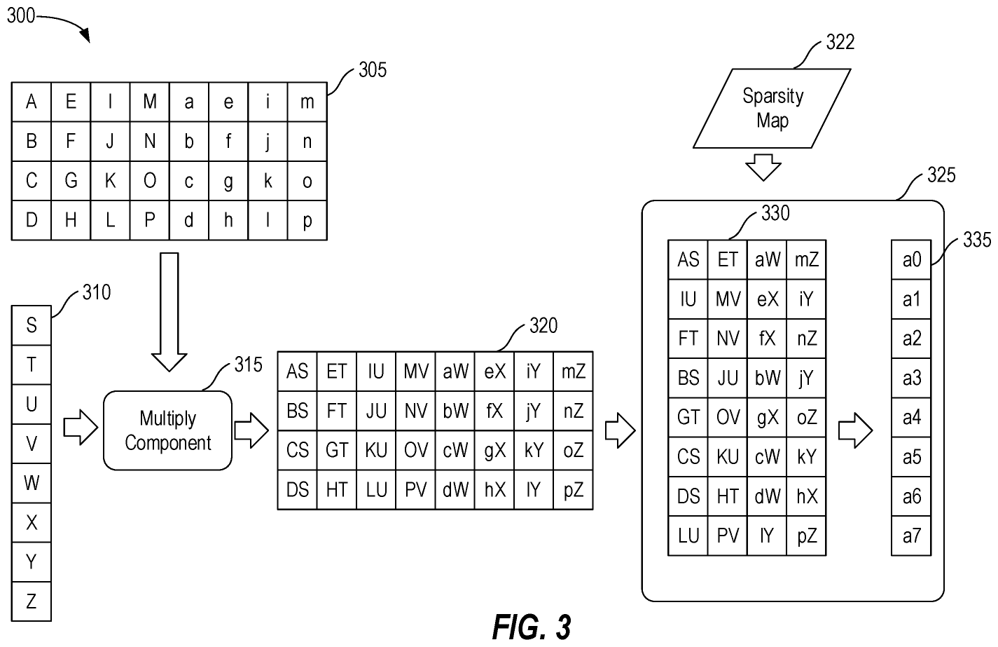

FIG. 3 depicts an example workflow 300 for performing sparse accumulation during a convolution operation using densified weight tensors.

In the illustrated example, a multiply component 315 receives a densified weight tensor 305 and an activation tensor 310, and generates a set of one or more intermediate tensors 320, also referred to as a products tensor 320. Although the activation tensor 305 is depicted as a single column (e.g., a column vector) for conceptual clarity, in aspects, the activation tensor 305 may have any dimensionality.

Generally, the depicted convolution involves multiplying each element in the activation tensor 310 with one or more elements in the densified weight tensor 305, and accumulating the results based on the sparsity map 322 that corresponds to the densified weight tensor 305. As illustrated, the multiply component 320 generates the intermediate tensor(s) 320 by multiplying each element in the activation tensor 310 with the weights in a corresponding column of the densified weight tensor 305.

Specifically, the first element in the activation tensor 310 (“S”) is multiplied with the weights in the first column of the densified weight tensor 305 (weights “A, “B,” “C,” and “D”) to yield the first column of the intermediate tensor(s) 320 (products “AS,” “BS,” “CS,” and “DS”). As discussed above, in conventional systems, these products may then be row-wise accumulated (e.g., summed) to yield the output tensor. In some aspects, this conventional row-wise accumulation can also be used in the case of horizontal squeezing (though the multiplication process used to generate the intermediate tensor(s) 320 may differ to ensure proper association of the activation elements and the weight elements).

In the illustrated workflow 300, however, a sparse accumulation 325 is performed using the sparsity map 322. Specifically, the sparsity map 322 can be used to determine, for each product in the intermediate tensor(s) 320, the corresponding row or accumulator for the output. That is, the sparse accumulation 325 may effectively involve rearranging the products in the intermediate tensor(s) 320 to provide each to the appropriate accumulator, as indicated in the block 330.

As illustrated, the first output element in the output tensor 335 (labeled as “a0” in the depicted example) is generated based on the products “AS,” “ET,” “aW,” and “mZ.” Referring back to FIG. 1, note that the weights used to generate these products (“A”, “E,” “a,” and “m”) are each in the first row of the original weight tensor 105. In this way, the “a0” output element is generated by accumulating (e.g., summing) the corresponding products “AS,” “ET,” “aW,” and “mZ.” Using the sparsity map 322, each product is therefore provided to the appropriate accumulator to be aggregated (e.g., summed) with the other products belonging to the corresponding element of the output tensor 335.

As discussed above, this sparse accumulation results in an output tensor 335 that is equivalent to the one that would be generated using the original weight tensor 105. This is because convolution using the original tensor (having weights with zero values) would result in a number of products having a value of zero, which do not affect the ultimate output. In this way, the sparsity map 322, coupled with directional squeezing of the weight tensor, enables efficient accumulation of the products (and, therefore, efficient use of the densified weight tensor 305) without imposing any structure or sparsity requirements on the weight tensor or compression process. Further, in some aspects, the techniques described herein do not negatively affect the accuracy of the convolution or model, as the output is mathematically equivalent despite requiring fewer operations and computational resources.

### Example Method for Densifying Weight Tensors

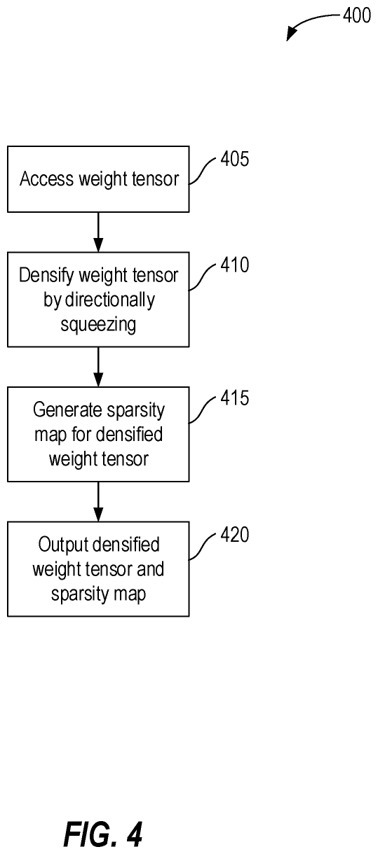

FIG. 4 depicts an example flow diagram illustrating a method 400 for densifying weight tensors.

At block 405, a weight tensor (e.g., weight tensor 105 in FIG. 1) is accessed for processing (e.g., by a squeeze component, such as the squeeze component 110 of FIG. 1). As used herein, “accessing” data may generally include receiving (e.g., from a transmission or from another component or system), requesting, retrieving (e.g., from storage or memory), or otherwise gaining access to the data. In an aspect, as discussed above, the weight tensor may generally correspond to a set of parameters that have been learned (or are being learned) during a training process of a machine learning model. For example, while training a neural network, a set of weights may be learned for the various kernels and/or layers of the network. Although the illustrated example depicts receiving and processing a single weight tensor, the method 400 may be used to process any number of weight tensors sequentially and/or in parallel. Generally, the weight tensor may be of any size, and have any amount and distribution of sparsity.

At block 410, the squeeze component densifies the weight tensor using directional squeezing. Generally, as discussed above, this directional squeezing includes compressing the weight tensor in either the horizontal or vertical direction, removing any zero-value elements in the process. In some aspects, as discussed above, the squeeze map may optionally insert one or more zero-value elements (or allow one or more zero-value elements to remain in the densified tensor) to enable the sparsity map to use fewer bits for each element (e.g., for relative gap indications).

At block 415, the squeeze component also generates a sparsity map (e.g., sparsity map 120 in FIG. 1, 120A in FIG. 2A, and/or 120B in FIG. 2B) for the densified weight tensor. The sparsity map generally indicates the association between elements in the densified weight tensor (and, therefore, products generated using the weights and input activations) and elements of the output tensor that is generated using the weight tensor. As discussed above, the sparsity map may include these indications explicitly (e.g., using absolute values) or implicitly (e.g., using relative values).

At block 420, the densified weight tensor (e.g., densified tensor 115 in FIG. 1) and sparsity map are then output for downstream use. In some aspects, the method 400 is performed offline (e.g., before runtime inferencing). For example, the method 400 may be performed after the model is trained (e.g., by the compiler as part of the model compilation). The (compiled) model, including the densified weight tensor and sparsity map, can then be provided for inferencing.

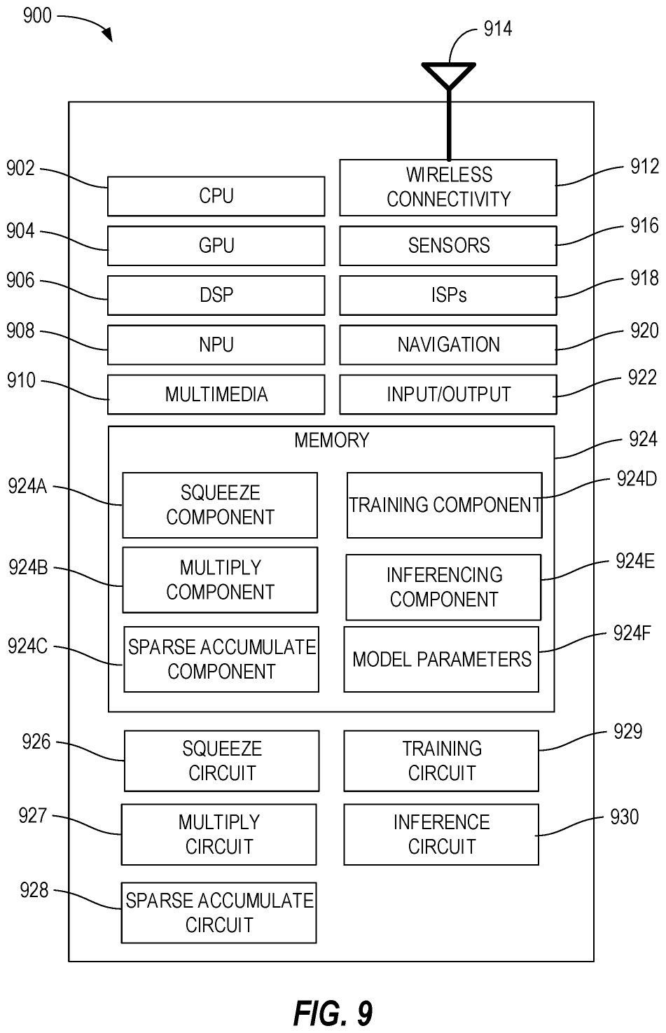

In some examples, the model may be trained, densified, compiled, and used on one or more systems. That is, a first computing system may be used to train the model, densify the weight tensors, and compile the model into an executable/instantiable model, while a second system may use the compiled data to instantiate a local copy of the model, and use this model for generating inferences at runtime. In some aspects, the densification and compiling may also be performed on a third system, distinct from the training system and inferencing system. In other aspects, a single system may train, densify, compile, and use the model (e.g., as discussed below with reference to FIG. 9).

Note that FIG. 4 is just one example of a method, and other methods including fewer, additional, or alternative steps are possible consistent with this disclosure.

### Example Method for Selectively Densifying Weight Tensors

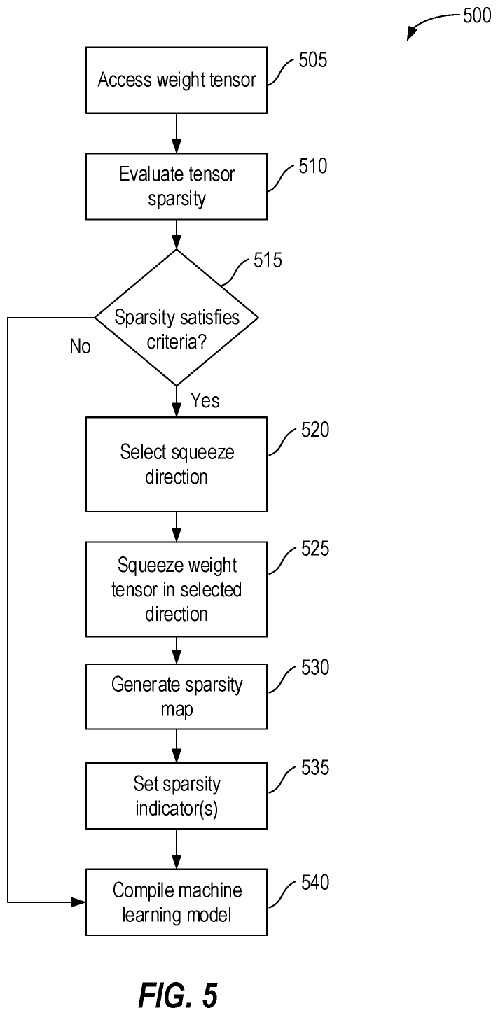

FIG. 5 depicts an example flow diagram illustrating a method 500 for selectively densifying weight tensors. In some aspects, the method 500 provides additional detail for the densification process discussed above with reference to FIG. 4.

At block 505, a weight tensor (e.g., weight tensor 105 in FIG. 1) is accessed for processing (e.g., by a squeeze component, such as the squeeze component 110 of FIG. 1). As discussed above, the weight tensor may generally correspond to a set of parameters that have been learned (or are being learned) during a training process of a machine learning model. Generally, the weight tensor may be of any size, and have any amount and distribution of sparsity. Although the illustrated example depicts receiving and processing a single weight tensor, the method 500 may be used to process any number of weight tensors sequentially or in parallel.

At block 510, the system (e.g., the squeeze component) evaluates the sparsity of the received weight tensor. In at least one aspect, evaluating the tensor sparsity can include determining which elements are zero-value (e.g., based on one or more rules specifying that weights satisfying predefined criteria are to be considered “sparse” or “zero-value”). In some aspects, evaluating the sparsity includes determining the percentage of the elements that are zero-value, the distribution of the sparsity, and the like.

At block 515, the system determines whether the determined sparsity satisfies one or more defined criteria. Generally, this criteria can include a wide variety of evaluations. For example, in some aspects, the system determines whether the sparsity meets or exceeds a defined minimum amount (e.g., specifying that the weight tensor must be at least 50% sparse). This can allow the system to avoid introducing densification and sparsity map overhead when the sparsity is relatively low.

If, at block 515, it is determine that the sparsity does not satisfy the criteria (e.g., because the weight tensor is insufficiently sparse), the method 500 continues to block 540, where the machine learning model is compiled, including the received weight tensor, for future use in inferencing during runtime. For example, if the weight tensor is insufficiently sparse, then the system may determine that the computational overhead needed to densify it, generate a sparsity map, and/or use the densified tensor at runtime are not justified by the efficiency that would be gained by the densification process.

Returning to block 515, if the sparsity satisfies the one or more criteria, then the method 500 continues to block 520, where the squeeze component selects a direction to squeeze the tensor. In some aspects, the direction is selected based on a predefined configuration. For example, a user may specify which direction to squeeze the weight tensor(s) based on a variety of factors, including the shape of the weight tensor(s), the distribution of sparsity in the tensor(s), the hardware that will be used during inferencing, and the like. In other aspects, the system may evaluate these and other factors using a set of rules in order to select a squeeze direction.

At block 525, the squeeze component then densifies the weight tensor by squeezing it in the selected direction (e.g., vertically or horizontally) (e.g., to create densified tensor 115 of FIG. 1). As discussed above, directionally squeezing the tensor generally involves compressing it in the selected direction, removing any zero-value elements or values in the process. In some aspects, as discussed above, the squeeze map may optionally insert one or more zero-value elements (or allow one or more zero-value elements to remain in the densified tensor) to enable the sparsity map to use fewer bits for each element (e.g., for relative gap indications).

At block 530, the squeeze component also generates a sparsity map (e.g., sparsity map 120 in FIG. 1, 120A in FIG. 2A, and/or 120B in FIG. 2B) based on the squeezing. This sparsity map may generally indicate the associations between the densified tensor and the output tensor, as discussed above. In some aspects (such as when using horizontal squeezing), the sparsity map may indicate the associations between the weight elements in the densified tensor and the activation elements in input tensors. The sparsity map may use absolute indications, relative indications, or any suitable technique to indicate the associations.

At block 535, the system also sets one or more sparsity indicator(s) to indicate the presence of the densified weight tensor. That is, the system may set one or more bits or other indicators to indicate that the machine learning model includes the densified tensor and sparsity map. In this way, at runtime, the inferencing system can check the sparsity indicator(s) to determine whether to use conventional convolution and accumulation or sparse convolution and/or sparse accumulation when processing input data using the weight tensor.

In at least one aspect, the sparsity indicator(s) can indicate, for each weight tensor in the model (e.g., for each kernel, or for each layer of a neural network) whether the tensor or layer has been densified. This can allow the squeeze component to dynamically densify (or refrain from densifying) each set of weights in a model based on the individual sparsity of each set, and further allows the inferencing system(s) to dynamically determine whether a given tensor has been densified and therefore should be processed using sparse convolution or accumulation, as discussed above.

At block 540, the system then compiles the machine learning model, including the densified tensor, the sparsity map, and the sparsity indicator(s), for future use. As discussed, above, the model may be trained, densified, compiled, and used on one or more systems. That is, a first computing system may be used to train the model, densify the weight tensors, and compile the model into an executable/instantiable model, while a second system may use the compiled data to instantiate a local copy of the model, and use this model for generating inferences at runtime. In some aspects, the densification and compiling may also be performed on a third system, distinct from the training system and inferencing system. In other aspects, a single system may train, densify, compile, and use the model (e.g., as discussed below with reference to FIG. 9).

Note that FIG. 5 is just one example of a method, and other methods including fewer, additional, or alternative steps are possible consistent with this disclosure.

### Example Method for Performing Desparsified Convolution Using Densified Weight Tensors

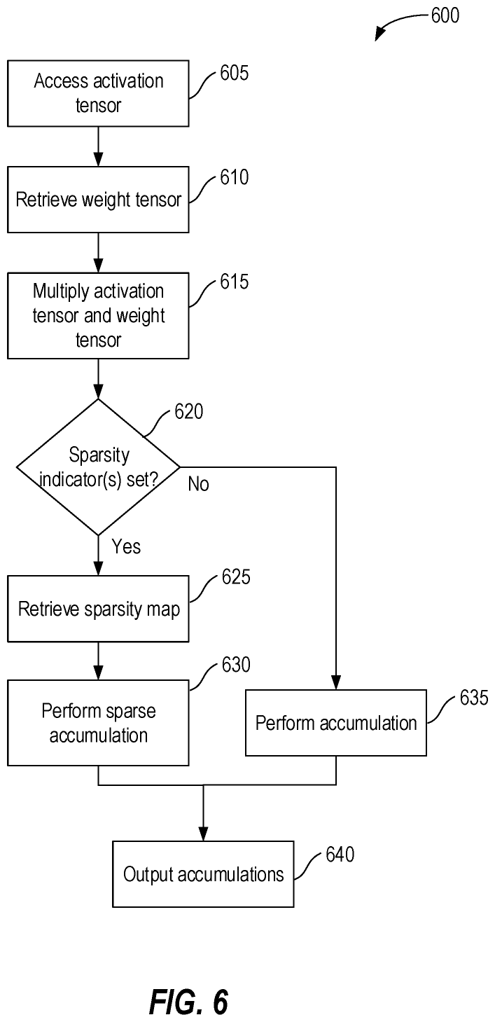

FIG. 6 depicts an example flow diagram illustrating a method 600 for performing desparsified convolution using densified weight tensors. In some aspects, the method 600 is performed by an inferencing system that uses pre-trained models (trained and/or compiled locally, or trained and/or compiled on one or more remote systems) to generate inferences at runtime.

At block 605, the inferencing system accesses an activation tensor. For example, the activation tensor may be output from a prior layer in a neural network, for processing at a current layer. In some aspects, the received tensor may be an original input tensor to the model, rather than an activation tensor.

At block 610, the inferencing system receives or retrieves a weight tensor to be used to process the received activations. For example, as discussed above, if the activations are received at a given layer of a neural network, then the inferencing system can determine which weight tensor(s) correspond to the given layer, and retrieve them (e.g., from memory) to use in convolving the activations. In some examples, the weight tensors are convolved with the received activations, though the techniques described herein are readily applicable to other model architectures as well.

At block 615, the inferencing system generates one or more intermediate tensors by multiplying the activations and the retrieved weight tensor. For example, as discussed above with reference to FIG. 3, each element in the activation tensor may be multiplied by a corresponding set of elements in the weight tensor.

At block 620, the inferencing system determines whether the one or more sparsity indicators associated with the weight tensor are set, indicating that the retrieved weight tensor has been densified by directional squeezing. If not, then the method 600 continues to block 635, where the intermediate values are accumulated using conventional techniques. The method 600 then continues to block 640.

If, at block 620, the inferencing system determines that the weight tensor has been densified, the method 600 continues to block 625, where the system retrieves the corresponding sparsity map for the densified tensor. At block 630, the system then performs sparse accumulation of the intermediate tensor(s) based on this sparsity map. For example, as discussed above with reference to FIG. 3, the inferencing system may use the sparsity map to determine which set of intermediate values (e.g., which set of weights) correspond to each respective output element in the output tensor, and accumulate these identified elements. The method 600 then continues to block 640.

At block 640, the system outputs the accumulated values. This may include, for example, outputting the accumulations as input to an activation function, as input to a downstream layer of a neural network, as output from the machine learning model, and the like. In some aspects, the method 600 is repeated for each layer (or some subset of layers) of the neural network, thereby enabling dynamic use of densified or conventional weight tensors at each layer.

The illustrated example describes use of a vertically squeezed weight tensor. As discussed above, vertical squeezing can enable the multiplication to be performed using fixed mappings (e.g., where each activation element is multiplied by a specific and fixed set of weights, such as a specific column in the weight tensor). The accumulation is then performed using the specific sparsity map.

In some aspects, however, horizontal squeezing may result in some or all of the weights being in different columns than the weights originally were (in the original weight tensor). Therefore, in some aspects, the system may determine whether the tensor was densified, as well as the directionality of that densification (e.g., indicated using the sparsity indicator(s) for the weight tensor), prior to performing the multiplication. For example, if the tensor was horizontally squeezed, then the inferencing system may retrieve the sparsity map and use it to identify, for each weight, the corresponding activation. As discussed above, though this horizontal squeezing introduces needed mappings for the multiplication process, the accumulation process can be performed using the conventional (fixed) process.

Note that FIG. 6 is just one example of a method, and other methods including fewer, additional, or alternative steps are possible consistent with this disclosure.

### Example Method for Densifying Weigh Tensors Using Directional Squeezing

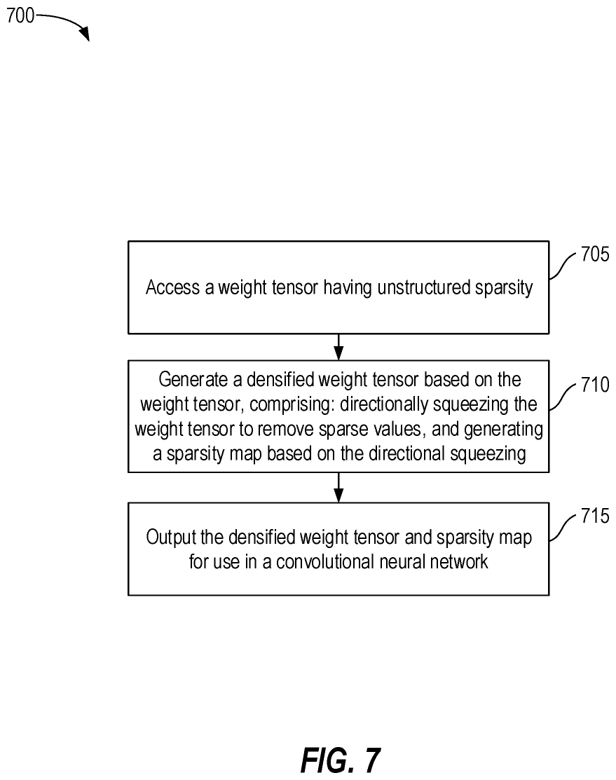

FIG. 7 depicts an example flow diagram illustrating a method 700 for densifying tensors using directional squeezing.

At block 705, a weight tensor having unstructured sparsity is accessed.

At block 710, a densified weight tensor is generated based on the weight tensor, comprising directionally squeezing the weight tensor to remove zero-value or sparse values, and generating a sparsity map based on the directional squeezing.

At block 715, the densified weight tensor and sparsity map are output for use in a convolutional neural network.

In some aspects, outputting the densified weight tensor and sparsity map comprises compiling the convolutional neural network based at least in part on the densified weight tensor.

In some aspects, compiling the convolutional neural network comprises setting a sparsity indicator to indicate that the compiled convolutional neural network includes the densified weight tensor.

In some aspects, directionally squeezing the weight tensor comprises removing zero-value or sparse elements from the weight tensor, and compressing remaining elements of the weight tensor along one dimension in the weight tensor.

In some aspects, directionally squeezing the weight tensor comprises selecting either a vertical direction or a horizontal direction, and squeezing the weight tensor in the selected direction.

In some aspects, a dimensionality of the sparsity map matches a dimensionality of the densified weight tensor, and the sparsity map indicates associations between elements in the densified weight tensor and corresponding output elements for the densified weight tensor during convolution.

In some aspects, the sparsity map indicates the associations using, for each element in the densified weight tensor, an absolute indication of the corresponding output element.

In some aspects, the sparsity map indicates the associations using, for each respective element in the densified weight tensor, a relative spacing indicating a number of output elements to skip between the respective element and a subsequent element in the densified weight tensor.

In some aspects, generating the densified weight tensor is performed in response to determining that the unstructured sparsity in the weight tensor satisfies one or more defined thresholds.

Note that FIG. 7 is just one example of a method, and other methods including fewer, additional, or alternative steps are possible consistent with this disclosure.

### Example Method for Convolving with Densified Weight Tensors

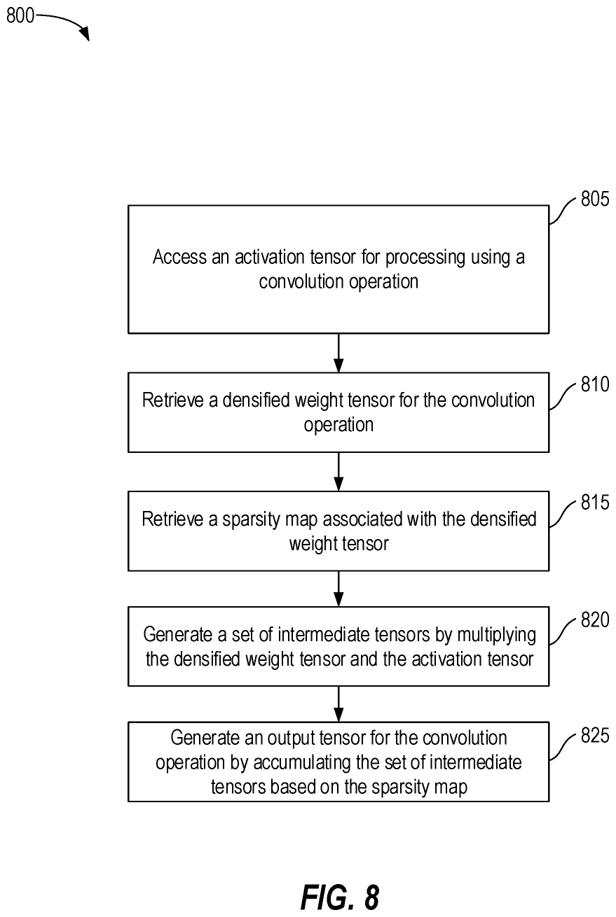

FIG. 8 depicts an example flow diagram illustrating a method 800 for convolving with densified weight tensors.

At block 805, an activation tensor is accessed for processing using a convolution operation.

At block 810, a densified weight tensor for the convolution operation is retrieved.

At block 815, a sparsity map associated with the densified weight tensor is retrieved.

At block 820, a set of intermediate tensors is generated by multiplying the densified weight tensor and the activation tensor.

At block 825, an output tensor for the convolution operation is generated by accumulating the set of intermediate tensors based on the sparsity map.

In some aspects, the densified weight tensor was generated by directionally squeezing a weight tensor, having unstructured sparsity, to remove zero-value elements or values, and the sparsity map indicates associations between elements in the densified weight tensor and corresponding output elements in the output tensor.

In some aspects, the sparsity map indicates the associations using, for each element in the densified weight tensor, an absolute indication of the corresponding output element.

In some aspects, the sparsity map indicates the associations using, for each respective element in the densified weight tensor, a relative spacing indicating a number of output elements to skip between the respective element and a subsequent element in the output tensor.

In some aspects, generating the output tensor comprises, for each respective output element in the output tensor identifying a respective set of elements, from the set of intermediate tensors, that correspond to the respective output element based on the sparsity map, and accumulating the respective set of elements.

In some aspects, accumulating the set of intermediate tensors based on the sparsity map is performed in response to determining that a sparsity indicator associated with the convolution operation indicates that at least one densified weight tensor is used in the convolution operation.

Note that FIG. 8 is just one example of a method, and other methods including fewer, additional, or alternative steps are possible consistent with this disclosure.

### Example Processing System for Desparsified Convolution

In some aspects, the workflows, techniques, and methods described with reference to FIGS. 1-8 may be implemented on one or more devices or systems. FIG. 9 depicts an example processing system 900 configured to perform various aspects of the present disclosure, including, for example, the techniques and methods described with respect to FIGS. 1-9. In one aspect, the processing system 900 may correspond to a training and/or compiler system that uses the above-discussed technique to train model(s), densify parameter tensor(s), generate sparsity map(s), compile model(s), and/or use models for runtime inferencing. In at least some aspects, as discussed above, the operations described below with respect to the processing system 900 may be distributed across any number of devices. For example, one system may compile models using densified weight tensors, while a second uses the trained models to inference using sparse accumulation and/or multiplication.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a squeeze component 924A, a multiply component 924B, a sparse accumulate component 924C, a training component 924D, and an inference component 924E. The memory 924 also includes a set of model parameters 924F, which may correspond to the original and/or densified parameters (e.g., weights and/or biases) of the machine learning models discussed above. The depicted components, and others not depicted, may be configured to perform various aspects of the techniques described herein. Though depicted as discrete components for conceptual clarity in FIG. 9, squeeze component 924A, multiply component 924B, sparse accumulate component 924C, training component 924D, and inference component 924E may be collectively or individually implemented in various aspects.

Processing system 900 further comprises squeeze circuit 926, multiply circuit 927, sparse accumulate circuit 928, training circuit 929, and inference circuit 930. The depicted circuits, and others not depicted, may be configured to perform various aspects of the techniques described herein.

For example, squeeze component 924A and squeeze circuit 926 may be used to directionally squeeze parameter tensors and generate sparsity maps, as discussed above with reference to FIGS. 1, 2A, 2B, 4, 5, and/or 6. Multiply component 924B and multiply circuit 927 may be used to generate intermediate tensor(s) based on input data (e.g., activations) and weight tensors during runtime inferencing, as discussed above with reference to FIGS. 3, 6, and/or 8. Sparse accumulate component 924C and sparse accumulate circuit 928 may generally be used to perform sparse accumulation of the intermediate tensors based on sparsity maps, as discussed above with reference to FIGS. 3, 6, and/or 8. Training component 924D and training circuit 929 may be used to control training, refining, and/or fine-tuning of various machine learning models that can then be densified using the above-discussed techniques, as discussed above with reference to FIGS. 1, 2A, 2B, 4, 5, and/or 6. Inference component 924E and inference circuit 930 may generally be use trained machine learning models having densified tensor(s) to generate inferences or predictions, as discussed above with reference to FIGS. 3, 6, and/or 8.

Though depicted as separate components and circuits for clarity in FIG. 9, squeeze circuit 926, multiply circuit 927, sparse accumulate circuit 928, training circuit 929, and inference circuit 930 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia component 910, wireless connectivity 912, sensors 916, ISPs 918, and/or navigation component 920 may be omitted in other aspects. Further, aspects of processing system 900 maybe distributed between multiple devices.

### Example Clauses

Clause 1: A method, comprising: accessing a weight tensor having unstructured sparsity; generating a densified weight tensor based on the weight tensor, comprising: directionally squeezing the weight tensor to remove zero-value elements or sparse values; and generating a sparsity map based on the directional squeezing; and outputting the densified weight tensor and sparsity map for use in a convolutional neural network.

Clause 2: The method according to Clause 1, wherein outputting the densified weight tensor and sparsity map comprises compiling the convolutional neural network based at least in part on the densified weight tensor.

Clause 3: The method according to any one of Clauses 1-2, wherein compiling the convolutional neural network comprises setting a sparsity indicator to indicate that the compiled convolutional neural network includes the densified weight tensor.

Clause 4: The method according to any one of Clauses 1-3, wherein directionally squeezing the weight tensor comprises: removing zero-value elements or sparse elements/values from the weight tensor; and compressing remaining elements of the weight tensor along one dimension in the weight tensor.

Clause 5: The method according to any one of Clauses 1-4, wherein directionally squeezing the weight tensor comprises: selecting either a vertical direction or a horizontal direction; and squeezing the weight tensor in the selected direction.

Clause 6: The method according to any one of Clauses 1-5, wherein: a dimensionality of the sparsity map matches a dimensionality of the densified weight tensor; and the sparsity map indicates associations between elements in the densified weight tensor and corresponding output elements for the densified weight tensor during convolution.

Clause 7: The method according to any one of Clauses 1-6, wherein the sparsity map indicates the associations using, for each element in the densified weight tensor, an absolute indication of the corresponding output element.

Clause 8: The method according to any one of Clauses 1-7, wherein the sparsity map indicates the associations using, for each respective element in the densified weight tensor, a relative spacing indicating a number of output elements to skip between the respective element and a subsequent element in the densified weight tensor.

Clause 9: The method according to any one of Clauses 1-8, wherein generating the densified weight tensor is performed in response to determining that the unstructured sparsity in the weight tensor satisfies one or more defined thresholds.

Clause 10: A method, comprising: accessing an activation tensor for processing using a convolution operation; and performing the convolution operation, comprising: retrieving a densified weight tensor for the convolution operation; retrieving a sparsity map associated with the densified weight tensor; generating a set of intermediate tensors by multiplying the densified weight tensor and the activation tensor; and generating an output tensor for the convolution operation by accumulating the set of intermediate tensors based on the sparsity map.

Clause 11: The method according to Clause 10, wherein: the densified weight tensor was generated by directionally squeezing a weight tensor, having unstructured sparsity, to remove zero-value elements or sparse values, and the sparsity map indicates associations between elements in the densified weight tensor and corresponding output elements in the output tensor.

Clause 12: The method according to any one of Clauses 10-11, wherein the sparsity map indicates the associations using, for each element in the densified weight tensor, an absolute indication of the corresponding output element.

Clause 13: The method according to any one of Clauses 10-12, wherein the sparsity map indicates the associations using, for each respective element in the densified weight tensor, a relative spacing indicating a number of output elements to skip between the respective element and a subsequent element in the output tensor.

Clause 14: The method according to any one of Clauses 10-13, wherein generating the output tensor comprises, for each respective output element in the output tensor: identifying a respective set of elements, from the set of intermediate tensors, that correspond to the respective output element based on the sparsity map; and accumulating the respective set of elements.

Clause 15: The method according to any one of Clauses 10-14, wherein accumulating the set of intermediate tensors based on the sparsity map is performed in response to determining that a sparsity indicator associated with the convolution operation indicates that at least one densified weight tensor is used in the convolution operation.

Clause 16: A system, comprising: a memory comprising computer-executable instructions; and one or more processors configured to execute the computer-executable instructions and cause the processing system to perform a method in accordance with any one of Clauses 1-15.

Clause 17: A system, comprising means for performing a method in accordance with any one of Clauses 1-15.

Clause 18: A non-transitory computer-readable medium comprising computer-executable instructions that, when executed by one or more processors of a processing system, cause the processing system to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
accessing a weight tensor having unstructured sparsity;
generating a densified weight tensor based on the weight tensor, comprising:
directionally squeezing the weight tensor to remove zero-value elements; and
generating a sparsity map based on the directional squeezing; and
outputting the densified weight tensor and sparsity map for use in a convolutional neural network.

2. The processor-implemented method of claim 1, wherein outputting the densified weight tensor and sparsity map comprises compiling the convolutional neural network based at least in part on the densified weight tensor.

3. The processor-implemented method of claim 2, wherein compiling the convolutional neural network comprises setting a sparsity indicator to indicate that the compiled convolutional neural network includes the densified weight tensor.

4. The processor-implemented method of claim 1, wherein directionally squeezing the weight tensor comprises:
removing zero-value elements from the weight tensor; and
compressing remaining elements of the weight tensor along one dimension in the weight tensor.

5. The processor-implemented method of claim 1, wherein directionally squeezing the weight tensor comprises:
selecting either a vertical direction or a horizontal direction; and
squeezing the weight tensor in the selected direction.

6. The processor-implemented method of claim 1, wherein:
a dimensionality of the sparsity map matches a dimensionality of the densified weight tensor; and
the sparsity map indicates associations between elements in the densified weight tensor and corresponding output elements for the densified weight tensor during convolution.

7. The processor-implemented method of claim 6, wherein the sparsity map indicates the associations using, for each element in the densified weight tensor, an absolute indication of the corresponding output element.

8. The processor-implemented method of claim 6, wherein the sparsity map indicates the associations using, for each respective element in the densified weight tensor, a relative spacing indicating a number of output elements to skip between the respective element and a subsequent element in the densified weight tensor.

9. The processor-implemented method of claim 1, wherein generating the densified weight tensor is performed in response to determining that the unstructured sparsity in the weight tensor satisfies one or more defined thresholds.

10. A processor-implemented method, comprising:
accessing an activation tensor for processing using a convolution operation; and
performing the convolution operation, comprising:
retrieving a densified weight tensor for the convolution operation;
retrieving a sparsity map associated with the densified weight tensor;
generating a set of intermediate tensors by multiplying the densified weight tensor and the activation tensor; and
generating an output tensor for the convolution operation by accumulating the set of intermediate tensors based on the sparsity map.

11. The processor-implemented method of claim 10, wherein:
the densified weight tensor was generated by directionally squeezing a weight tensor, having unstructured sparsity, to remove zero-value elements, and
the sparsity map indicates associations between elements in the densified weight tensor and corresponding output elements in the output tensor.

12. The processor-implemented method of claim 11, wherein the sparsity map indicates the associations using, for each element in the densified weight tensor, an absolute indication of the corresponding output element.

13. The processor-implemented method of claim 11, wherein the sparsity map indicates the associations using, for each respective element in the densified weight tensor, a relative spacing indicating a number of output elements to skip between the respective element and a subsequent element in the output tensor.

14. The processor-implemented method of claim 10, wherein generating the output tensor comprises, for each respective output element in the output tensor:
identifying a respective set of elements, from the set of intermediate tensors, that correspond to the respective output element based on the sparsity map; and
accumulating the respective set of elements.

15. The processor-implemented method of claim 10, wherein accumulating the set of intermediate tensors based on the sparsity map is performed in response to determining that a sparsity indicator associated with the convolution operation indicates that at least one densified weight tensor is used in the convolution operation.

16. A system, comprising:
a memory comprising computer-executable instructions; and
one or more processors configured to execute the computer-executable instructions and cause the system to perform an operation comprising:
accessing a weight tensor having unstructured sparsity;
generating a densified weight tensor based on the weight tensor, comprising:
directionally squeezing the weight tensor to remove zero-value elements; and
generating a sparsity map based on the directional squeezing; and
outputting the densified weight tensor and sparsity map for use in a convolutional neural network.

17. The system of claim 16, wherein outputting the densified weight tensor and sparsity map comprises compiling the convolutional neural network based at least in part on the densified weight tensor.

18. The system of claim 17, wherein compiling the convolutional neural network comprises setting a sparsity indicator to indicate that the compiled convolutional neural network includes the densified weight tensor.

19. The system of claim 16, wherein directionally squeezing the weight tensor comprises:
removing zero-value elements from the weight tensor; and
compressing remaining elements of the weight tensor along one dimension in the weight tensor.

20. The system of claim 16, wherein directionally squeezing the weight tensor comprises:
selecting either a vertical direction or a horizontal direction; and
squeezing the weight tensor in the selected direction.

21. The system of claim 16, wherein:
a dimensionality of the sparsity map matches a dimensionality of the densified weight tensor; and
the sparsity map indicates associations between elements in the densified weight tensor and corresponding output elements for the densified weight tensor during convolution.

22. The system of claim 21, wherein the sparsity map indicates the associations using, for each element in the densified weight tensor, an absolute indication of the corresponding output element.

23. The system of claim 21, wherein the sparsity map indicates the associations using, for each respective element in the densified weight tensor, a relative spacing indicating a number of output elements to skip between the respective element and a subsequent element in the densified weight tensor.

24. The system of claim 16, wherein generating the densified weight tensor is performed in response to determining that the unstructured sparsity in the weight tensor satisfies one or more defined thresholds.

25. One or more non-transitory computer-readable media comprising instructions that, when executed by one or more processors of a processing system, cause the processing system to perform an operation comprising:
accessing an activation tensor for processing using a convolution operation; and
performing the convolution operation, comprising:
retrieving a densified weight tensor for the convolution operation;
retrieving a sparsity map associated with the densified weight tensor;
generating a set of intermediate tensors by multiplying the densified weight tensor and the activation tensor; and
generating an output tensor for the convolution operation by accumulating the set of intermediate tensors based on the sparsity map.

26. The one or more non-transitory computer-readable media of claim 25, wherein:
the densified weight tensor was generated by directionally squeezing a weight tensor, having unstructured sparsity, to remove zero-value elements, and
the sparsity map indicates associations between elements in the densified weight tensor and corresponding output elements in the output tensor.

27. The one or more non-transitory computer-readable media of claim 26, wherein the sparsity map indicates the associations using, for each element in the densified weight tensor, an absolute indication of the corresponding output element.

28. The one or more non-transitory computer-readable media of claim 26, wherein the sparsity map indicates the associations using, for each respective element in the densified weight tensor, a relative spacing indicating a number of output elements to skip between the respective element and a subsequent element in the output tensor.

29. The one or more non-transitory computer-readable media of claim 25, wherein generating the output tensor comprises, for each respective output element in the output tensor:
identifying a respective set of elements, from the set of intermediate tensors, that correspond to the respective output element based on the sparsity map; and
accumulating the respective set of elements.

30. The one or more non-transitory computer-readable media of claim 25, wherein accumulating the set of intermediate tensors based on the sparsity map is performed in response to determining that a sparsity indicator associated with the convolution operation indicates that at least one densified weight tensor is used in the convolution operation.
